(19) United States
(12) Patent Application Publication
(10) Pub. No.: US 2005/0102869 A1
(43) Pub. Date: May 19, 2005

(54) Fluid suspended self-rotating body and method

(76) Inventor: William W. French, Cardiff, CA (US)

Correspondence Address: CHARMASSON & BUCHACA & LEACH LLP, 1545 HOTEL CIRCLE SOUTH, SUITE 150, SAN DIEGO, CA, 92108-3412, US

(21) Appl. No.: 10/652,925

(22) Filed: Aug. 28, 2003

Related U.S. Application Data
(60) Provisional application No. 60/406,897, filed on Aug. 29, 2002.
(60) Provisional application No. 60/407,890, filed on Sep. 3, 2002.
(60) Provisional application No. 60/407,891, filed on Sep. 3, 2002.
(60) Provisional application No. 60/412,729, filed on Sep. 23, 2002.

(51) Int. Cl. G09F 19/02

(52) U.S. Cl. 40/414

(57) ABSTRACT

In a display device where a moving object is immersed in a fluid filling a transparent sealed, vesel (72) and is rotated by an internal electrical mechanism that derives it power from a photo cell (128) and its counter torque from an internal compass (140), the index of refraction of the fluid is adjusted by addition of water to match the index of refraction of the vesel material. The formula of the fluid is also tailored to minimize, absorption of ambient moisture into the vessel. In one embodiment of the electrical spinning mechanism, the magnet acts both as a biasing compass and as a magnetic field generator for the motor. In a second embodiment of the spinning mechanism, the stator is constituted by a multipole ring-shaped magnet (120) that does not interfere with the operation of the biasing compass magnet (140). Multiple windings in the electrical spinning mechanism are energized through a split-ring and brush commutator (92) that use the mechanism shaft (122) as conductor.

### FIELD OF THE INVENTION

The instant invention relates to self-starting and self-powered display devices, and more particularly, to self-spinning globes powered by radiated energy.

### BACKGROUND OF THE INVENTION

Various types of novelty structures which move with either no apparent support, drive mechanism, or power input are often used as toys, decorative conversation pieces or advertising media. Various embodiments of such structures have been disclosed in U.S. Pat. No. 5,435,086 Huang et al., Japanese Patents Nos. 10137451, 101431101, and 10171383, all by Hirose Mamoru, Japanese Patents Nos. 7210081, 7219426, and 7239652 all to Taragi Hiroshi and German Patents Nos. DE19706736 Fushoellier, DE3725723 Steinbrinck, and DE 41377175 Lang. Most prior embodiments are not totally free of external connection. If they are not firmly anchored to an outer support, they require complex and bulky countertorque-producing mechanisms such as fan blades or other internal heavy and complex systems that consume a great deal of electrical power.

The countertorque-producing mechanisms and their supports are very evident to an observer, and do not create any interest or appreciation of ambient energy fields.

U.S. Pat. No. 4,419,283 discloses the use of a combination of two or more immiscible fluids to buoyantly support small objects. This patent does not address the avoidance of bubbles resulting from the expansion of the container and problems created by excessive internal pressure resulting from absorption of ambient moisture.

The present invention results from an attempt to devise and intriguing and educational moving structure that requires a very low level of power derived from an ambient field of electromagnetic radiation, and avoid the creation of bubbles in the supporting fluid of some displays as well as deformation of the container due to excessive internal pressure.

### SUMMARY OF THE INVENTION

The principal and secondary objects of this invention are to provide the simplest and least power-demanding rotating display that can operate for extremely long periods of time without any apparent driving mechanism, input of power, or support bearing, and that may be suitable for use as a toy, advertising medium, novelty, or robotic component of a remote space or underwater installation.

In the preferred embodiment of the invention, these and other valuable objects are achieved by floating a sealed and hollow object spinning in a volume of fluid held within a transparent sealed container. The container is suspended or otherwise supported by a tripod or other like structure. The internal drive mechanism is anchored, in other words, derives its spinning force in co-reaction with, or biased by, either the earth's magnetic field or another man-made magnetic field. Power for the motor or electromagnets is obtained by collecting light waves that impinge upon the enclosure throught the use of photovoltaic cells.

Various commutating mechanisms for selectively and sequentially enabling the electromagnets are disclosed.

The preferred embodiment of the invention will be perceived as a replica of the planet earth floating in space and spinning forever in a stately way.

The fluid supporting the enclosure is a combination of liquids that are formulated to resist absorption of ambient moisture.

The drive mechanism is compact and self-contained, that is, housed within the object, if not the container.

### BRIEF DESCRIPTION OF THE DRAWING

FIG. 1a is a side sectional view of a preferred embodiment of the invention;

FIG. 1b is a top view thereof;

FIG. 2 is a side sectional view of a first alternate embodiment;

FIG. 3 is a side sectional view of a second alternate embodiment;

FIG. 4a is an expanded side sectional view of the drive of the second alternate embodiment;

FIG. 4b is a top sectional view of the drive of the second alternate embodiment;

FIG. 5 is a side sectional view of a third alternate embodiment;

FIG. 6a is a side sectional view of a fourth alternate embodiment;

FIG. 6b is a top view thereof;

FIG. 7a is a side sectional view of a fifth alternate embodiment;

FIG. 7b is a top view thereof;

FIG. 8a is a side sectional view of a sixth alternate embodiment;

FIG. 8b is a top view thereof;

FIG. 9 is a side sectional view of a seventh alternate embodiment;

FIG. 10 is a graph of the Propylene Glycol weight percentage necessary in Propylene Glycol/water mixtures to be at equilibrium with the water vapor in air as a function of the relative humidity of the air;

FIG. 11 is a graph of the indices of refraction of various mixtures of Gylcols and water as a function of the weight percentage of the Glycol in the mixture;

FIG. 12 is a chart of the average relative humidity over a two year period for various cities in the USA;

FIG. 13a is a side, sectional view of the preferred embodiment of the drive mechanism;

FIG. 13b is a top view of key elements thereof;

FIGS. 14a, 14b and 14c are top views of a commutation sequence for said mechanism;

FIG. 15 is a side, sectional view of a first alternate embodiment of the mechanism;

FIG. 16 is a side, sectional view of a second alternate embodiment of the mechanism;

FIG. 17 is a side, sectional view of a third alternate embodiment of the mechanism;

FIG. 18a is a side, sectional view of a fourth alternate embodiment of the mechanism;

FIG. 18b is an expanded top view of the commutator rings and brushes for the fourth alternate embodiment;

FIG. 18c is an electrical schematic view of the connections between coils and commutator segments of the device of FIG. 18a;

FIG. 19a is a side sectional view of a drive mechanism for the preferred embodiment of FIG. 1;

FIG. 19b is a top view thereof with the motor top removed;

FIG. 20a is the motor magnet and the compass magnet of the device of FIG. 19a a particular relative angular orientation;

FIG. 20b is the motor magnet and the compass magnet of the device of FIG. 19a in a different relative angular orientation;

FIG. 21 is a side sectional view of how the drive mechanism of FIG. 19a mounted within a ball;

FIG. 22a is a top view of the armature structure of FIG. 19b in a particular starting orientation with respect to the ring magnet of FIG. 1b;

FIG. 22b is an expanded view of the split ring assembly and brushes of FIG. 21a; and

FIGS. 23a, 23b, 23c, 23d, 25a and 25b are progression of relative angular orientations of the a armature structure and the ring magnet and brushes as the ring magnet and brushes are driven to rotate in a counterclockwise direction.

### DESCRIPTION OF THE PREFERRED EMBODIMENT OF THE INVENTION

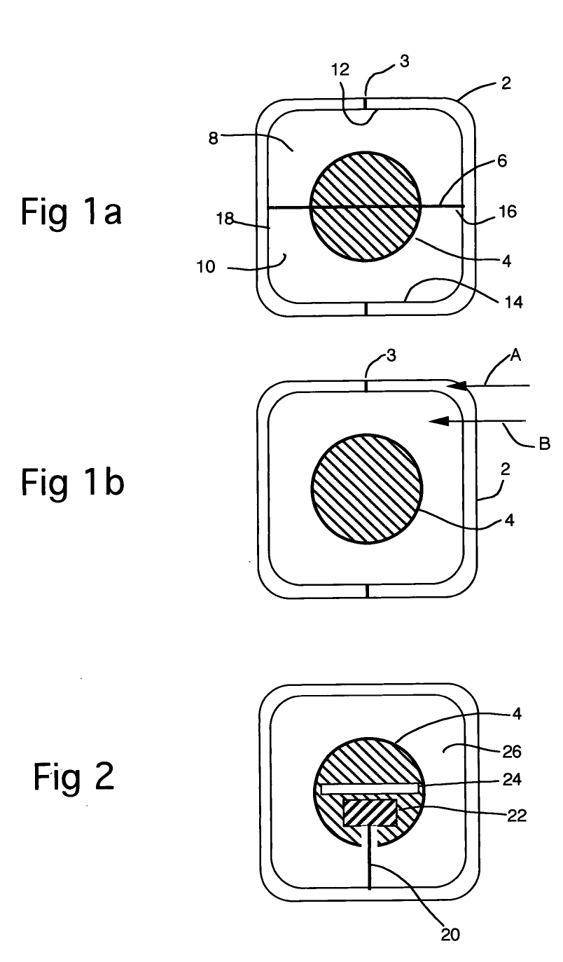

Referring now to the drawing, there is shown in FIGS. 1a and 1b, a display device comprising a transparent case 2 containing a ball 4 floating near the interface 6 of a lighter fluid 8 such as NOPAR 12 and a heavier fluid 10 such as Propylene Glycol. The ball 4 can be driven to rotate by internal mechanisms as described below, and preferably has graphic features on its surface such as the features of the earth. The lighter fluid 8 and the heavier fluid 10 are immiscible and, preferably both transparent. The density of the ball 4 is made to be such that it is between the density of the lighter fluid 8 and the heavier fluid 10, so the ball will float in the absence of any mechanical link with either the top inside surface 12 or the bottom inside surface 14 of the case 2.

The enclosure or case 2 is shown as being one monolithic part, but it would actually be formed from at least two parts that would be fitted around the ball 4, and then be bonded together, preferably in a way that leaves a bond line 3 that is either invisible or difficult to see. For example, acrylic can be bonded together by the well-known process of solvent bonding, and the resulting bond line is very hard to see. If the case 2 were made of glass, then the bond could be formed using one of the common adhesives with a similar index of refraction to glass, or the glass could be bonded by heating the surfaces to be bonded to soften them, prior to pressing them together. A low temperature bonding glass could be used to allow a lower temperaturee process.

Preferably, the indices of refraction of the lighter fluid 8 and the heavier fluid 10 are close enough in value so that the interface 6 is not noticable to an observer. It is further preferable that the index of refraction of the case 2 material be about the same as the index of refraction of the fluids 8 and 10, so that the interface between the fluids and the case will not be noticeable. It is further preferable that the fluids 8 and 10 and the case 2 material have reasonably similar transmission properties such as color and transparency, so that an observer will not be able to distinguish any difference in the appearance of the block when looking down line of sight A, as compared to looking down line of sight B. Preferably, the volume between the ball 4 and the case 2 is completely filled with fluid, with no bubbles to give an observer any cue that the case is not a solid block of material.

The fluid combination is advantageous for many reasons, and both can have an index of refraction of 1.421 at 20° C., if the proper amount of water is mixed with the Propylene Glycol.

The index of refraction of acrylic can be as low as 1.46 in Plaskolite Optix R Acrylic Sheet made by Plaskolite, Inc. of Columbus, Ohio. While this is not identical to the value for fluids, it is close enough to make the fluid-case interface very difficult to notice, particularly if well-known principles of optical design are employed in designing the overall shape of the case. For example, all corners and edges are rounded and the case is made reasonably thin. The degree of light transmission is advantageously similar to this fluid combination and acrylic.

A better match of index or refraction to the NORPAR 12/Propylene Glycol fluid combination can be made by using Ausimont XPH-353 Fluoropolymer, made by Ausimont S.p.A. of Milan, Italy, which has an index of refraction of 1.434.

The top view of FIG. 1b shows the ball 4 in a central location within the case 2. The forces of surface tension between the fluids 8 and 10, the inside of the case at the interface 16, and the surface of the ball 2 can function to make this central location the equilibrium location for the ball 4 when it is not moving. For example, if the case 2 is made of acrylic, and the lighter fluid is NORPAR 12 and the heavier fluid 10 is a mixture of 15% by weight water and 85% by weight Propylene Glycol, and if the ball 4 is made of acrylic and coated with a surfactant, such as Sailkote™ made by McGee Industries, Aston, Pa., then the ball 4 will tend to float at an equilibrium position out of contact with the inside of the case at the interface 16. Regardless of the location of the ball when it is not rotating, it will tend to move toward the central location due to liquid shear forces when the ball starts rotating, as it will with subjected to an ambient field of energy, as described in the related applications.

The display device can present an observer with several intriguing aspects. First, if the observer does not notice the interface 6, because of the close similarity of the index of refraction of the fluids 8 and 10, then the observer will not have any clues as to how the ball 2 is supported for rotation. Even if the interface 6 were visible, the observer would have no clues as to what could be causing the ball 4 to rotate. And, if the case 2 is made as described, then the observer will have no clue as to how the ball 4 could rotate within a seemingly solid block of plastic.

In an alternate embodiment illustrated in FIG. 2, the support for the ball 4 is provided by a shaft 20 fixedly attached to the case 2, and connected to the rotor or stator of an electric motor 22, which is powered by ambient energy incident on a solar cell 24, connected to the motor 22 by wires not shown. Bearings, not shown, within the motor 22, allow the motor 22 to rotate with respect to the shaft 20. The ball 4 is powered and driven to rotate by the various means described below and supported for rotation by means of bearings between the shaft 20 and the ball 4. The shaft 20 is perferably made of a small diameter and of a material, such as described above, that closely matches the index of refraction of the fluid 26.

The ball 4 is now supported by the shaft 20, so there is no need to use the lighter fluid 8 and the heavier fluid 10 shown in FIG. 1, to stablize the height of the ball 4. Now the fluid 26 can be only NORPAR 12, and the density of the ball 4 can simply be made a reasonably close match to that of NORPAR 12.

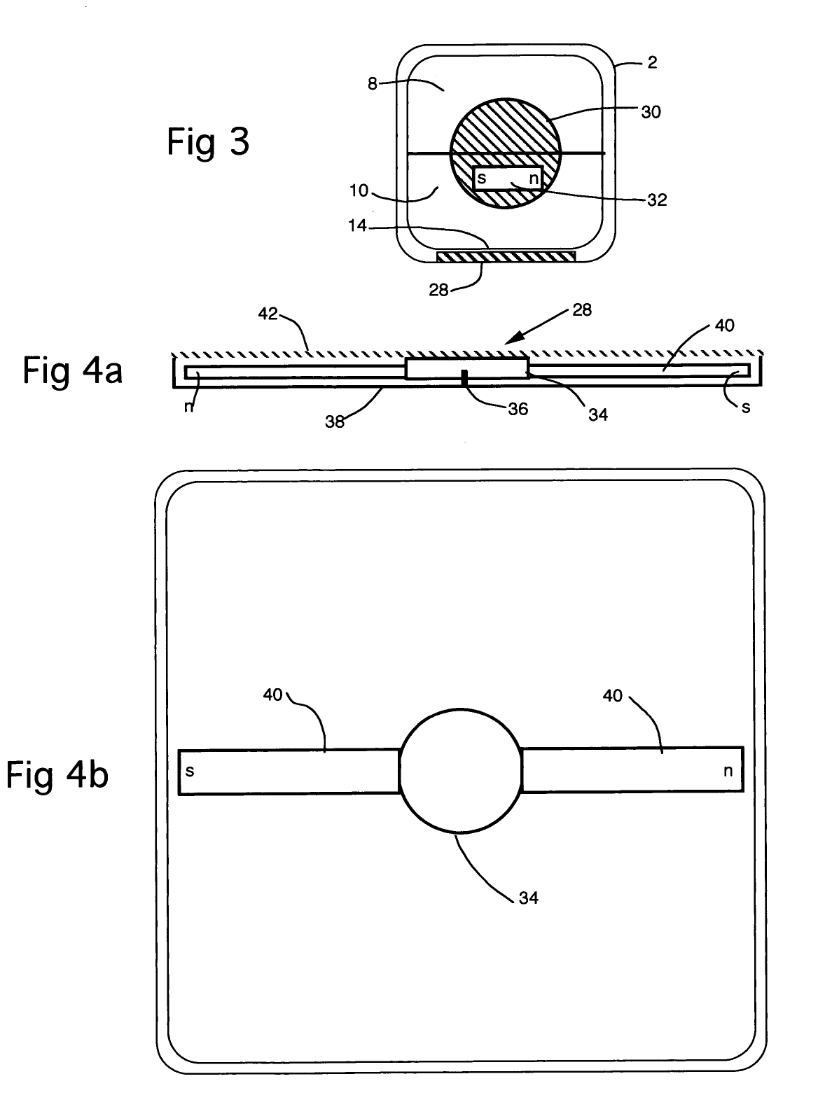

In a second alternate embodiment, as shown in FIGS. 3-4b, a motor assembly 28 embedded in the lower part of the case 2 drives a ball 30 by means of magnetic interactions. This embodiment used a lighter fluid 8 and a heavier fluid 10 to support the ball 30 well above the bottom surface 14. A magnet 32 is contained within the ball 30 for interfacing with a rotating magnetic field generated by the motor assembly 28, thereby causing the ball 3 to rotate.

An electric motor 34 is supported by means of a shaft 36 fixedly attached to the motor assembly case. The case of the motor 34 is fixedly attached to the bar magnet 40 with N and S poles oriented orthogonally to the shaft 36 of the motor as shown. A solar cell 42 is mounted within the motor assembly 28 above the motor, as shown in FIG. 4a. The case 2 and fluids 8 and 10, and the motor assembly case are all made of materials that are transparent enough to allow a substantial amount of light to reach the solar cell 42. The motor 34 is intended to be a type of motor that is powered by electric current delivered to the motor shaft 36. The wires that connect the solar cell 42 to the motor shaft 36 are not shown, for clarity. The solar cell 42 is not shown in the top view of FIG. 4b, for clarity in showing the motor 34 and the magnet 40, but the solar cell 42 can be the same shape as the motor assembly 28 and cover much of its area.

In operation, the motor 34 is powered to rotate, which induces rotation of the bar magnet 40, and the magnet interaction between the parallely oriented bar 40 magnet and ball magnet 32 induces rotation of the ball 30. The strength and size of the bar magnet 40 and the magnet 32 are selected, by principles well-known in the art, to have a sufficiently strong magnetic interaction to allow the rotation of the ball to be driven, but not so strong that the ball 30 will be pulled downward into contact with the bottom surface 14.

An observer of the embodiment illustrated in FIGS. 3 and 4 enjoys all the same illusions as described for the embodiment of FIG. 1, except the case 2 is not completely transparent, owing to the opacity of the motor assembly 28. Nevertheless, an observer can still be fooled into seeing the case as a solid block of plastic, as described for FIGS. 1a and 1b. This motor assembly is preferably made thin and can be imprinted on its upper surface 44 iwth various semi-transparent graphic features such as logos to allow the object to be used as an advertising premium.

Magnetic interactions between the object's magnet 32 and the motor's magnet 40 tend to maintain the ball 30 in a central location of the enclosure 2.

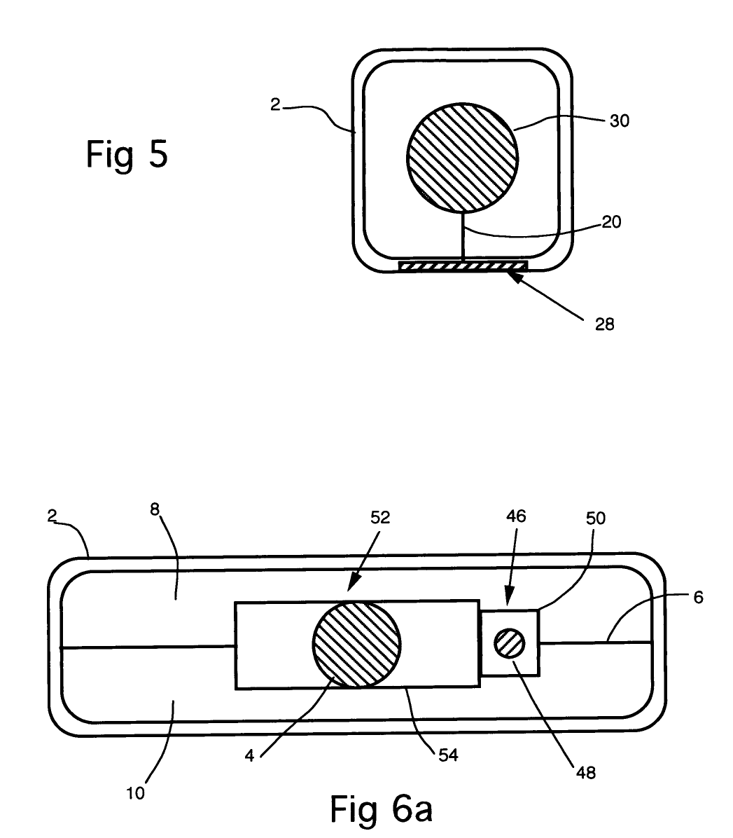

The structure and operation of a third embodiment, shown in FIG. 5, are similar to the embodiment of FIG. 3, except the ball 30 and the fluid 26 are similar to their counterparts shown in FIG. 2. Thus, a motor assembly 28 drives the rotation of the ball 3, that is immersed in a fluid 26 and supported by a pillar 20, the rotor of the motor being secured to the pillar.

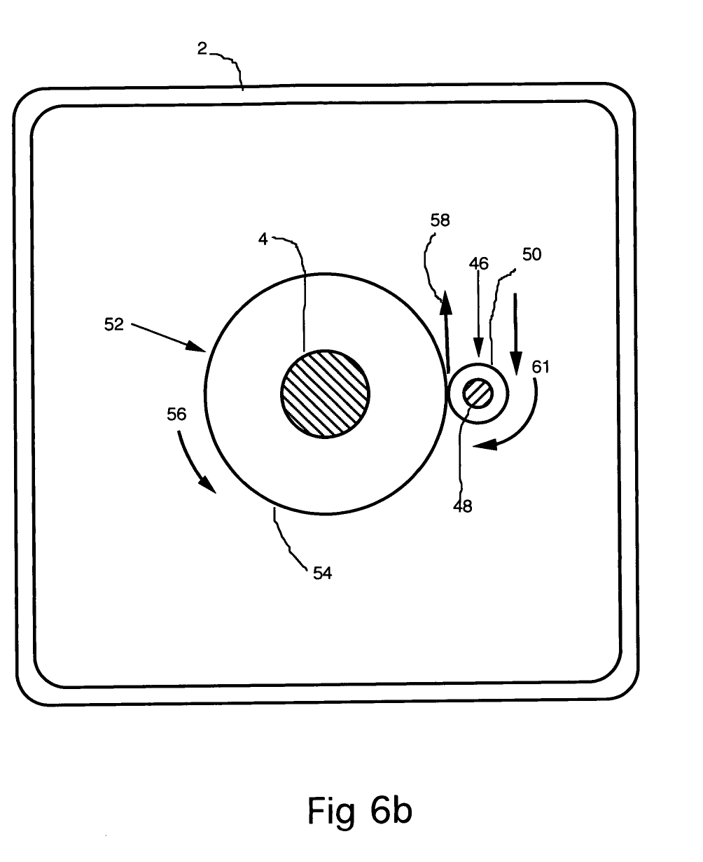

FIGS. 6a and 6b show a fourth embodiment, which includes a satellite assembly 46, comprising a satellite ball 48 embedded within a satellite shell 50. A ball assembly 52 comprises a ball 4 embedded within a ball shell 54. The satellite assembly 46 and the ball assembly are both supported by the buoyant forces of a lighter fluid 8 and a heavier fluid 10, to float near the fluid interface 6. The satellite shell 50 and the ball shell 54 are preferably both made of a material having an index of refraction substantially similar to those of the fluids and enclosure that will be essentially not visible to an observer, by virtue of the same optical principles described for the embodiment of FIG. 1.

FIG. 6b shows the ball assembly 52 and the satellite assembly essentially in contact and floating roughly in the center of the case 2 as would occur due to surface tension with the proper choice of fluids and materials. For example, the satellite shell 50 and the ball shell 52 can be made of acrylic, and the heavier fluid can be 15% by weight water and 85% by weight of Propylene Glycol and the lighter fluid can be NORPAR 12.

The ball surface 4 and the satellite ball 48 preferably have graphic features on their surfaces, such as earth features for ball 4 and moon features for satellite ball 48, that are consistent with their relative sizes and relative motions.

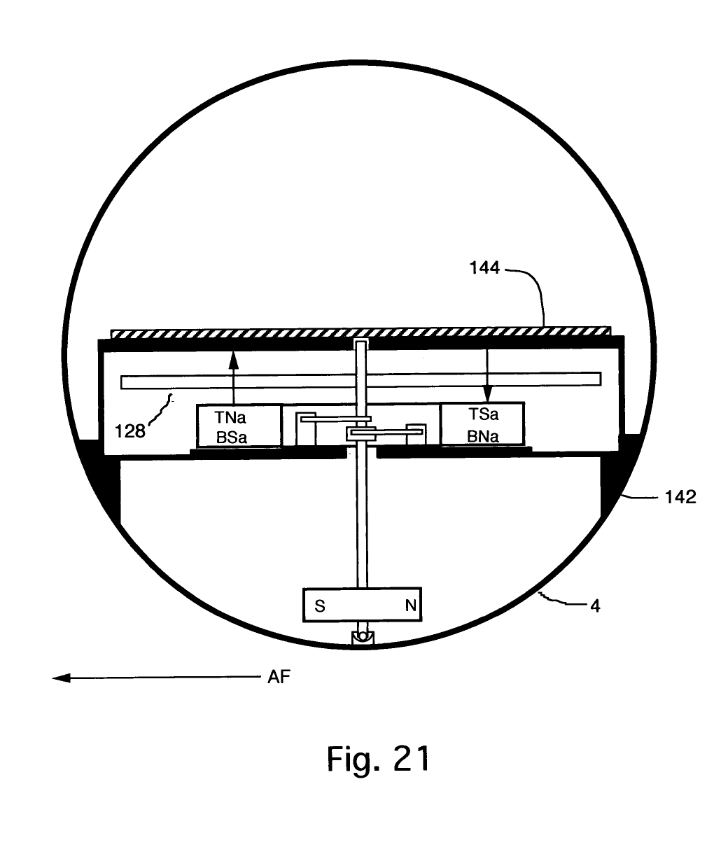

In operation, the ball 4 will be driven to rotate by the same kind of mechanisms described below in FIG. 21, and this will cause counterclockwise rotation 56 of the ball shell 54. Because of the proximity of the ball shell 54 and the satellite shell 50, a force 58 will tend to drag the satellite assembly along in the counterclockwise direction 56. The liquid shear force 60 will create a force coupled with the force 58 that will cause the clockwise rotation 61 of the satellite assembly 46.

An observer will see the ball 4 rotating, with no apparent support, and no apparent drive mechanism, apparently within a solid block of plastic, while the spinning satellite ball orbits around it.

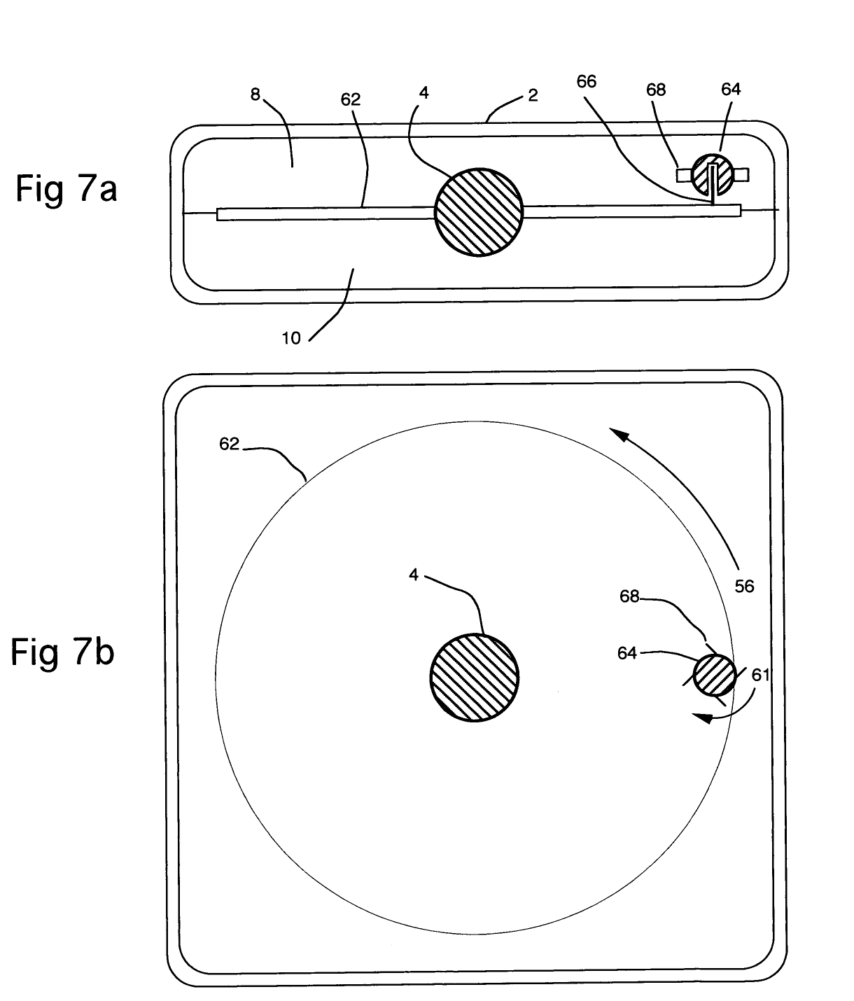

A fifth alternate embodiment is shown in FIG. 7a where a ball 4 fixedly attached near the center of a transparent disk 62. Both ball 4 and transparent disk 62 are supported for rotation by a lighter fluid 8 and a heavier fluid 10 within a case 2. A satellite ball 64 is supported for rotation on a shaft 66 fixedly attached to the transparent disk 62, shaft 66, and vanes are preferably made of a material that is transparent and has an index of refraction close enough to the index of refraction of the fluids, 8 and 10, so as to be essentially invisible. The vanes 68 are shaped and positioned to cause spinning of the satellite ball 64 when the disk 62 and ball 4 are spun.

In operation, as shown in FIG. 7b, the ball 4 is driven to rotate as described for previous embodiments. The courterclockwise rotation 56 of the transparent disk 62 causes the satellite ball 64 to move through the lighter fluid 8, and the vanes 68 cause clockwise rotation 61 of the satellite ball 64. An observer will be presented with the same visual effect as described for the display of FIGS. 6a and 6b.

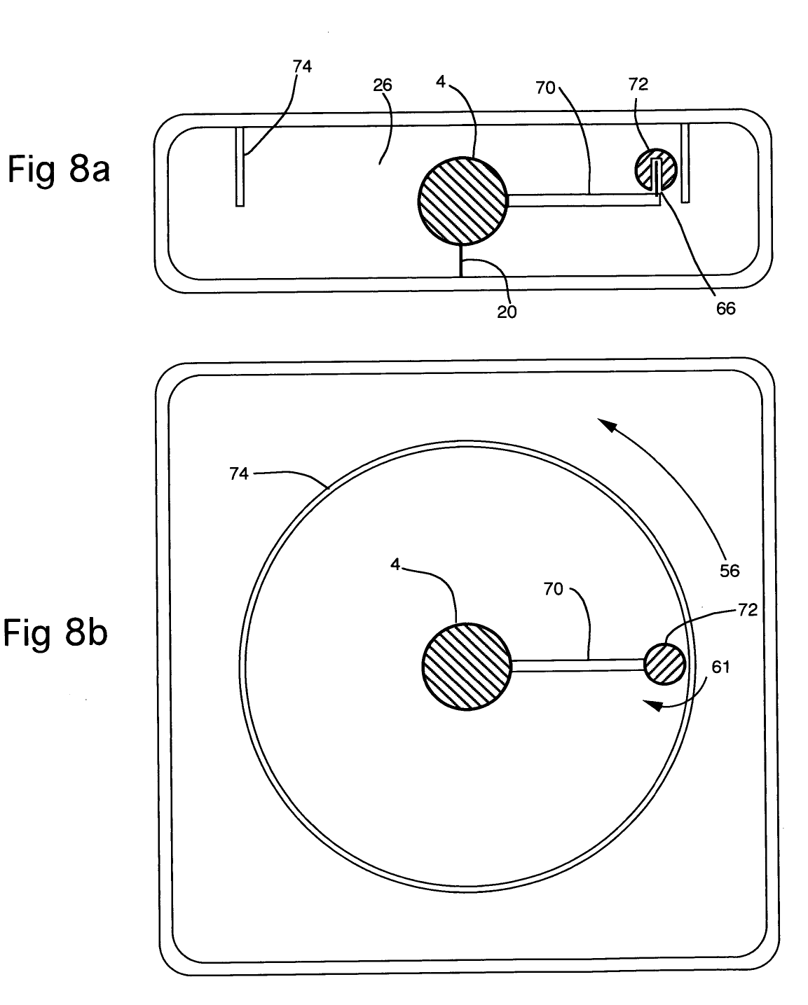

A sixth alternate embodiment is shown in FIGS. 8a and 8b, where a ball 4 is supported for rotation by a shaft 20. An arm 70 is fixedly attached to ball 4 for, and a shaft 66 fixedly attached to the arm 70 supports a satellite ball 72 for rotation. The case 2, filled with fluid 26, includes a cylindrical wall 74 made to be in close proximity to the satellite ball as ball 4 rotates.

In operation, ball 4 is driven to rotate in the counterclockwise direction 56, as described for previous embodiments, and ball 72 is moved through a circular path, in a counterclockwise direction, in proximity to the cylindrical wall 74. Liquid shear forces between the satellite ball 72 and the cylindrical wall 74 drive the clockwise rotation 61 of the satellite ball 72. The display presents an observer with a similar sight as described for FIGS. 6a and 6b.

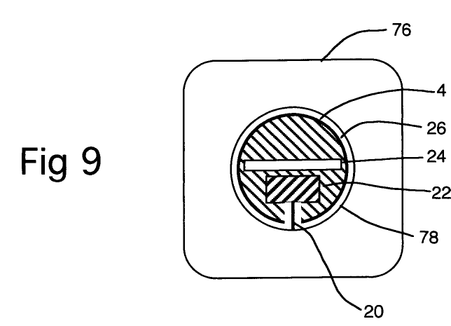

FIG. 9 shows a seventh alternate embodiment, which can be very similar to the embodiment shown in FIG. 2, or to other embodiments. A thick walled case 76 has a cavity 78 inside, which conforms to the shape of the ball 4. When the layer of fluid 26 is thin as shown, and when the index of refraction of the fluid 26 is greater than the index of refraction of the material that the case 78 is made of, then, according to well-known optical principles, graphical features on the surface of the ball 4 will be magnified and appear to be on the inside surface of the cavity 78 and so the cavity will not be visible to an observer.

The above-described embodiments and their features and parts can be combined in the art. The motor assembly 28 could create a rotating magnetic field not by rotating a bar magnet 40, but rather by the appropriate application of electric currents to electromagnets within the motor assembly 28 as explained below. The various drive mechanisms could be powered by internal batteries or power derived from the mains, rather than from ambient energy. All of the designs could include more than one of balls like ball 4 and the designs such as in FIGS. 6, 7 and 8 could clearly include more than one satellite ball. In most of the embodiments, the objects that rotate need not be a ball shape, indeed, they can have virtually any three-dimensional form, and the case 2 can be made in virtually any shape, such as a cylinder, box, cone, pyramid, or even irregular forms.

A wide range of materials for the fluids and cases can be considered, based on factors such as the index of refraction, clarity, cost, chemical resistance, and toxicity. For example, cane sugar can be mixed with water in various proportions to create a liquid with an index of refraction between 1.33 and 1.5. The list below includes some further examples of fluids and solids that can be used. This list is given to show examples of materials that are appropriate, but should not be taken to limit the choice to only these, because there are many appropriate materials, well-known to those skilled in the art.

| Name | Index of refraction |
|---|---|
| Benzyl acetate | 1.523 |
| Anisole | 1.518 |
| Various vegetable oils | 1.48 (approx.) |
| castor oil | 1.48 |
| Solid materials: | |
| Fused quartz | 1.459 |
| Pyrex glass | 1.48 |
| Butyrate | 1.475 |
| Methylpentene (Mitsui) | 1.463 |
| Chemicals America, Inc. | |

In any one of the previously described embodiments of the display device, the lighter fluid 8 can be a pure paraffinic oil, or a mixture of similar hydrocarbons such as NORPAR 12, sold by Exxon, Houston, Tex., USA. The heavier fluid is a solution of Propylene Glycol and water, 88% Propylene Glycol and 12% water, by weight. The lighter fluid 8 fills about 85% of the enclosure 2, and the heavier fluid 10 fills about 15%.

A bubble can form within the enclosure 2 when volume of the enclosure is greater than the total volume of the fluid, and such a bubble can provide a clear indictaion to an observer that the whole object is not rotating. For this reason, care should be taken that the bubbles not form. The total fluid volume and the volume of the enclosure 2 can change with temperature, and with the amount of water absorbed by the materials of the enclosure 2 and inner ball 4. Various sequences of environmental exposure can result in conditions that will cause a bubble to form. A general way to prevent this is to fill the enclosure 2 to a slight over-pressure, under the conditions least likely to form a bubble. This can be done during the manufacturing process.

However, over time, and with exposure to extreme temperatures, for example, all plastics will, to some degree, creep and essentially change their shape. Thus, a ball and shell with a sufficient over pressure to withstand the formation of a bubble at 20° C., can develop an essentially bigger fluid cavity 6 after exposure to a higher temperature, such as 40° C., for an extended period. In this case, lowering the temperature back to 20° C. would now precipitate the formation of a bubble.

The use of a humectant liquid within the enclosure, in this case the Propylene Glycol/water solution, can help overcome this problem of creep because such a liquid can absorb water from the surrounding atmosphere and essentially increase the total amount of fluid within the enclosure. The liquid combinations that have been used in the past, such as the NORPAR 12 and PFPE 5060 absorb very little moisture and could not do this effectively.

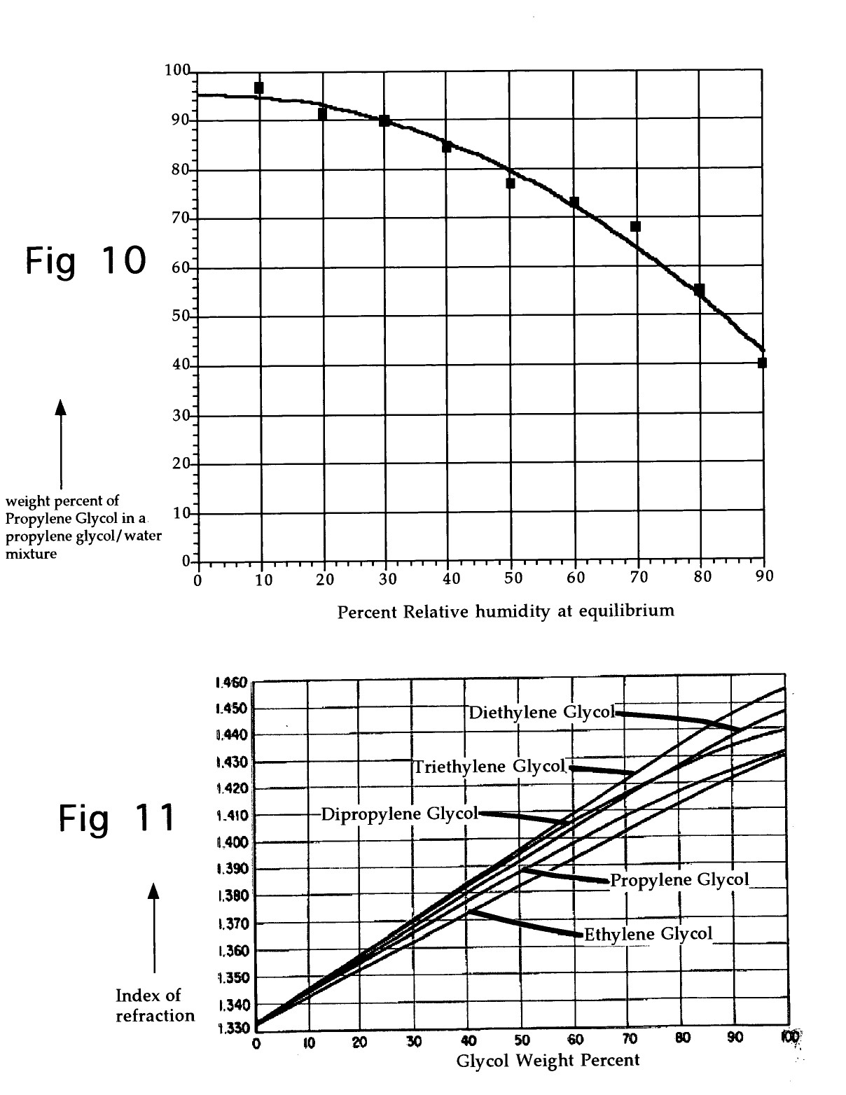

Propylene Glycol will absorb wter from an ambient atmosphere until a limit is reached, which depends on the relaive humidity of the ambient atmosphere. This relationship is shown in FIG. 10 for data published by the Dow Chemical Co., Midland, Mich. This graph shows that when water and Propylene Glycol are mixed at a weight percent of 88% Propylene Glycol and 12% water, then this mixture is at equilibrium with air at 35% relative humidity (“RH”).

When a humectant liquid is contained within a volume, such as the enclosure 2, the rate at which moisture will diffuse from the ambient atmosphere 18 through the material of the outer shell 2 is proportional to the humidity difference between the ambient atmosphere 18 and the equilibrium humidity value corresponding to the particular Propylene Glycol/water mixture on the inside. For example, in the case of the proposed 88/12% mixture, all things being equal, if the humidity of the ambient atmosphere 18 were 70% RH, then moisture would diffuse from the ambient atmosphere 18 and into the enclosure 2 at half the rate that it would if the humectant liquid were pure Propylene Glycol, since the 88/12% mixture of Propylene Glycol and water is at equilibrium at 35% relative humidity, so the effective humidity difference is 35% and not 70%. As moisture diffuses into the Propylene Glycol/water mixture, the relative weight percentages of Propylene Glycol and water change, generally leading to slower and slower rates of diffusion.

This absorption of water causes a buildup of pressure within the enclosure 2. Plastics can slowly change their dimensions by the process of creep, as mentioned already, but the likelihood that the plastic will actually fracture is greatly reduced if the rate of strain and the total magnitude are reduced. In the case of 70% ambient humidity, starting off with 88/12/5 Propylene Glycol to water cuts the rate of absorption in half and also cuts in half the totla amount of water that will finally be absorbed.

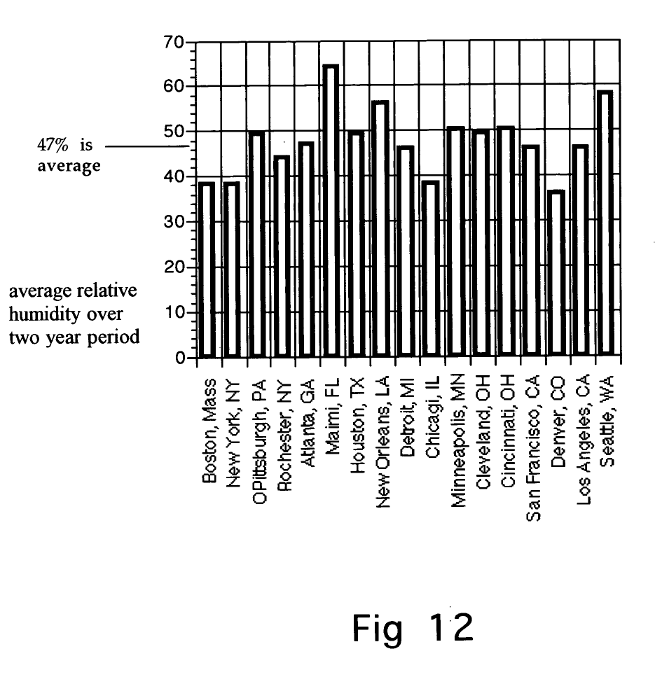

The graph in FIG. 12 shows data from Allied Chemical, Minneapolis, Minn. on the average relative humidity for a group of cities in the USA over a two year period. The average value is 475. Denver was the direst at 35% RH, while Miami was the wettest at 63% RH. Clearly, there are bit variations at all these locations throughout the year, but the process of water diffusion is slow, and the absorption is reversible, so the ball-in-shell will not swing wildly from season to season. A ball-in-shell made with the preferred 88/12% solution of Propylene Glycol and water would not from a bubble in Denver, and would slowly absorb water and expand in the other cities, again avoiding the formation of a bubble.

The amount of water that the ball-in-shell will eventually absorb is also proportional to the total amount of the humectant fluid within the fluid cavity. For this reason, it would seem a good idea to use a very small amount of the heavy fluid 10. However, the two fluids work together most effectively to stablize the height of the inner ball 4 with temperature changes when there is an equal amount of each fluid. The ability of the two fluid combination to regulate the floating height of the inner ball is completely gone when the percentage of either the heavier fluid 10 or the lighter fluid 8 is set at zero. The choice of how much of the heavier fluid to use is a compromise between the need for effective height regulation and the need to reduce the total amount of water that will eventually diffuse into the enclosure 2.

The effectiveness of the ball-in-shell illusion is also very much improved if the indices of refraction for the two fluids are essentially similar. This makes the interface between the fluids hard to notice and thereby eliminates another cue to observers about the true nature of the object. The indices of refraction of PFPE 5060 and NORPAR 12 are 1.251 and 1.416, respectively, at 25° C. The index of refraction of pure Propylene Glycol is seen on the chart of FIG. 11 to be 1.431, which is a better match to NORPAR 12 than PFPE 5060, but the proposed 88/12% per volume solution of Propylene Glycol and water has an index of 1.423. The ratio of the refractive index of pure Propylene Glycol to NORPAR 12 1.005, which is twice as close to the ideal value of 1.

One example of a display device consisting of a ball within an outer spherical container exhibit the following characteristics:
1) The container and inner ball 4 are made of acrylic.
2) The inner ball 4 outer diameter is 150 mm, and is 3 mm thick.
3) The outer shell inner diameter is 156 mm and is 3 mm thick.
4) The container is completely filled with fluid at 10° C. at atmospheric pressure. The lighter fluid 8 fills about 85% of enclosure 2, and the heavier fluid 10 fills about 15%.
5) The mass 14 of the drive is set so that a 20° C. the inner ball 4 floats at a vertical height of 3 mm from contact with the outer shell 2.

The invention shows just one example of how the instant invention can be applied. Objects of other sizes and shapes could clearly be made materials other than acrylic could be used. The relative amounts of the two fluids in the fluid cavity cn be changed to achieve a different trade-off between height regulation and the amount of water that will be absorbed. There are many humectants known to those skilled in the art that can be used according to teachings of the instant invention, and other fluids that can be used in place of paraffinic oils.

The exact ratio of Propylene Glycol to water can be shifted to other values, and even adding small percentages of water to the Glycols helps. For example, if it is known that a particular ball-in-shell will be operating in a very humid environment, such as Miami at 63%, then the volume ratio of Propylene Glycol to water could be set at 75% Propylene Glycol and 25% water. It would also be possible to choose the ratio of Propylene Glycol 78% and water 22% to achieve a virtually perfect match of the indices of refraction at 25° C. This 78/22 ratio would be at equilibrium with an ambient atmosphere of 53% RH, which is close to the USA average of 47%. Objects made with this 78/22 ratio would start off with a virtually invisible fluid interface and would lose water, on average in the USA and in much of the world, at a very slow rate. Mixtures of different humectants can clearly be made to achieve a wide range of humectant/water solutions that can match the index of refraction of NORPAR 12 perfectly over a reasonable range of equilibrium relative humidity values, and paraffin oils with different indices of refraction can be chosen to increase the range of relative humidity values that cn be matched.

Other hydrocarbon Glycerin alcohols beyond those shown in FIG. 11 may be conveniently mixed with water to adjust the index of refraction of the solution, and the degree of moisture absorption into the enclosure.

The following component drive mechanisms are intended for use as motors in the previously described display devices.

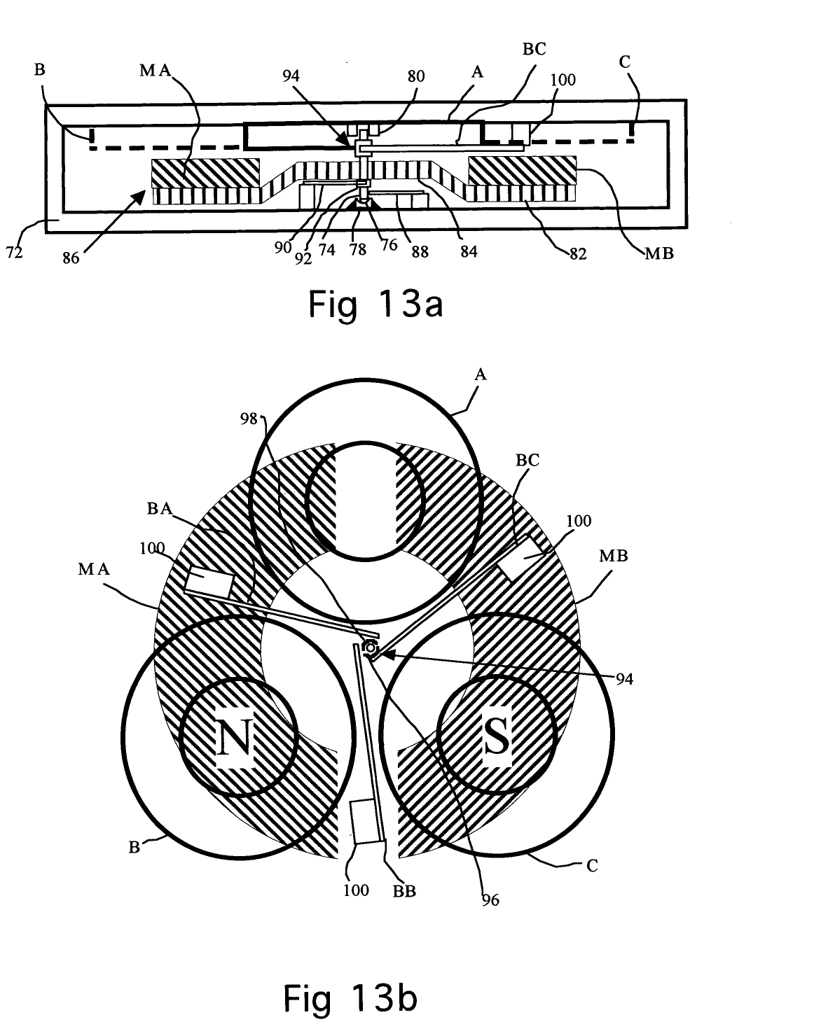

FIG. 13a shows a side sectional view of a non-magnetic motor case 72 containing the drive mechanism. An axle 74 is mounted in a vertical orientation, supported by a bearing comprising a ball 76 supported by a sapphire cup 78, said cup being constrained laterally by brackets 8 that can be part of the motor case 72. The axle 74 is constrained laterally near its top by a cylindrical journal 80 which can be a molded part of the motor case. A disk 82 made of magnetically permeable material such as soft iron is fixedly attached to the axle 74, perpendicular to said axle. The disk 82 has a central part 14 that has been formed to be above the outer parts of said disk. Two half-ring shaped permanent magnets, magnet MA and magnet MB, are mounted fixedly to the disk 84, as shown in FIG. 13a and the top view of FIG. 13b. The magnets are coaxial with the axle or shaft 74. The entire top surface of magnet MA is magnetized to be a N pole, and he entire top surface of magnet MB is magnetized to be a S pole.

The axle 74 with the disk 82 and the magnets MA and MB mounted as described, comprise a compass assembly 86, so long as the axle 74 is roughly in a vertical orientation, and said compass assembly will align itself with the ambient magnetic field, which can be simply the earth's magnetic field, and keep the axle in a fixed rotational position.

A group of 73 coils of wire, coil A, coil B, and coil C mounted proximate the magnets are clearly seen of FIG. 13b. The side sectional view shows side view of coil A and the dashed lines show where coils B and C are. All these coils, A, B and C, are fixedly attached to the inside upper surface of the motor case 72.

Electrical potentials are delivered to the group of coils, as shown in FIG. 13a, from an external source by means of a axle brush 88 rubbing on the axle 74, and a ring brush 90 rubbing on a slip ring 92, said slip ring being cylindrical in shape, concentric with the axle 74, and electrically insulated from said axle. The axle 74 is electrically conductive. The external source of electrical potential is not shown, but could be a battery or a solar cell mounted on the top outside of the motor case, or elsewhere. For simplicity, the wires connecting the potential source to the brushes 88 and 90 are not shown.

A split-ring assembly 94 is also mounted on the axle 74. This consists of two halves, a negative half 96 and a positive half 98, seen clearly FIG. 13b. Each ring is a 180° segment of a cylinder and is mounted on the axle 74 so that the central axis of each segment is coincident with the central axis of the axle 74. The positive half 96 is electrically connected to the axle 74 and the negative half 98 is electrically connected to the slip-ring 92, by wires not shown for clarity. The external source of electrical potential is connected to supply a positive potential to brush 88 and a negative potential to brush 90.

Three conductive brushes, brush BA, brush BB, and brush BC, are seen clearly in the top view of FIG. 13b. The side view in FIG. 1a only shows one of these brushes, brush BC, for clarity. These brushes are connected by wires not shown to the coils, A, B, and C. The said brushes are mounted on brush holders 100 which are fixedly attached to the motor case 72, as seen for brush BC in FIG. 13a.

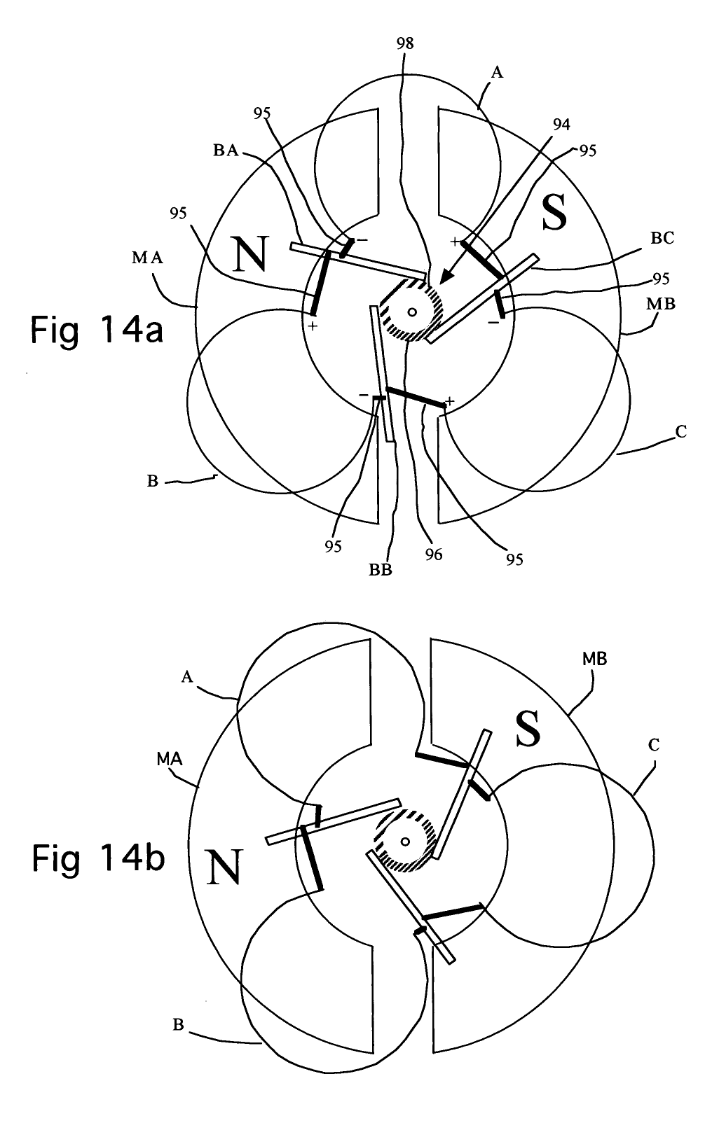

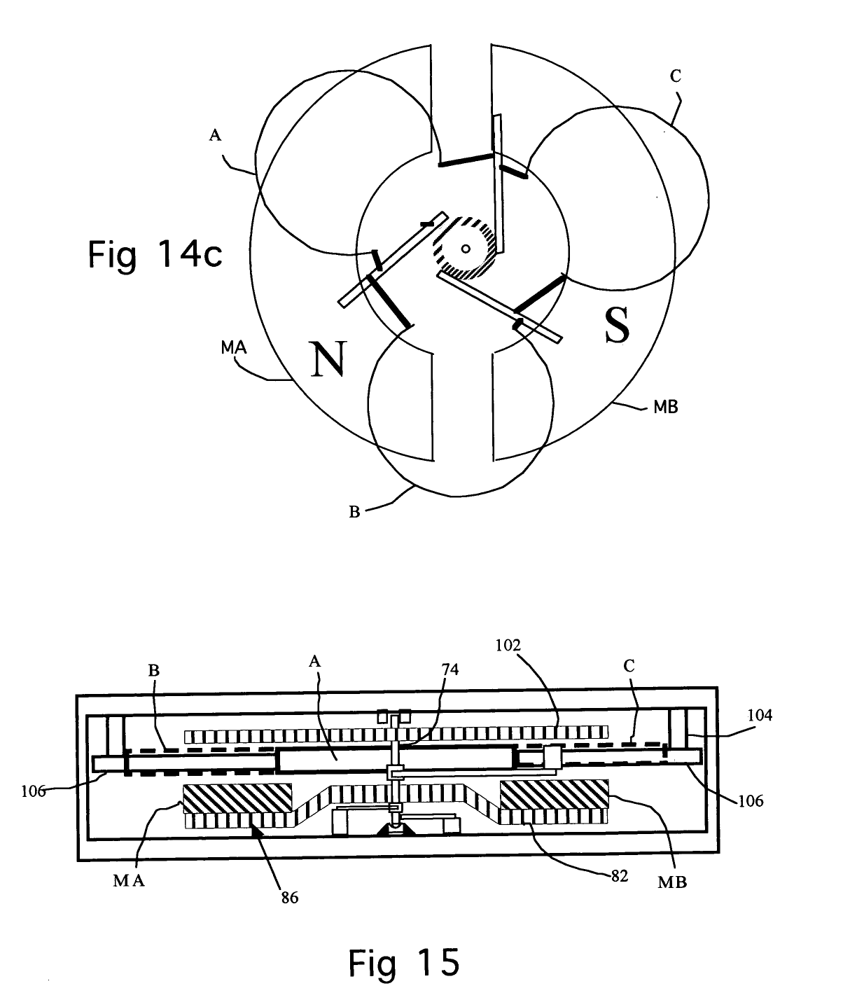

FIG. 14a shows a schematic view of the objects in FIG. 13b, with the split ring assembly 94 enlarged for clarity. The two wires that come from each coils are marked with + and − signs to indicate similar terminals of the coils. Electrical wires 95 shown in FIG. 14a connect brush BA to coil A− and coil B+, brush BB to coil B− and coil C+, and brush BC to coil C− and coil A+.

The compass assembly 16 in FIG. 14a is shown with its N pole on the left and S pole on the right, as it would align itself if the earths magnetic N pole were to the right, and S pole to the left. Other ambient magnetic fields can add to the earth's field, but this will not effect operation unless the net field becomes essentially zero.

With the initial conditions shown in FIG. 14a, current through coil A would flow in a direction that would urge coil A to move in a counter clockwise direction, coil B could have no current flow because brushes BA and BB are shorted together by the positive half 96 of the slip ring assembly 94, and coil C have current flowing in it, but would generate little torque because it is in a region of almost uniform magnetic field. The torque experienced by the coils is transferred to the motor case and the entire case is urged to rotate counter-clockwise. The magnet assembly is at the same time urged to rotate clock-wise, but its interaction with the ambient field hinders this rotation. If the motor case is free to rotate, because it is mounted within a floating object such as described above, then it will begin to rotate counter-clockwise.

After rotating about 30° the orientation shown in FIG. 14b is reached. Here coil A and coil B are both receiving current that urges continued counter-clockwise rotation, while coil C has become shorted and generates no torque. After rotating another 30° counter-clockwise, the orientation shown in FIG. 14c is reached. Here coil B is generating counter-clockwise torque, coil A is receiving current, but would generate little torque because it is in a region of almost uniform magnetic field, and coil C is receiving no current because it is shorted. Continued counter-clockwise rotation continues to apply currents to the coils to urge continued counter-clockwise rotation.

FIG. 15 shows a drive that is very similar to the drive of FIG. 13, but a top iron disk 102 has been added, fixedly attached to the axle 74, in close proximity of the coils and parallel to the disk 82. The coils A,B and C, cannot be mounted directly on the motor case 72 now, so standoffs 104 serve to mount a coil holder bracket 106 to the motor case 72. With this arrangement, the magnetic flux from the magnets MA and MB will be more concentrated within the area that coils A, B, and C move in, and so the torque generated by the coils will be higher. It is recognized that a tradeoff must be made between this desirable effect, and the weakening of the field that is created by the compass assembly 86 and that aligns it with the ambient magnetic field. An optimum design allows just enough flux to escape the compass assembly to stop the rotation of the compass during the operation of the drive in whatever environment has the weakest ambient field that the drive is designed to work in. The amount of flux that escapes depends on many well known principles of magnetic circuit design. A top iron disk 192 that is bigger in diameter, thicker, closer to disk 82, and made of a material with a higher saturation magnetization will hold more flux in the coil area.

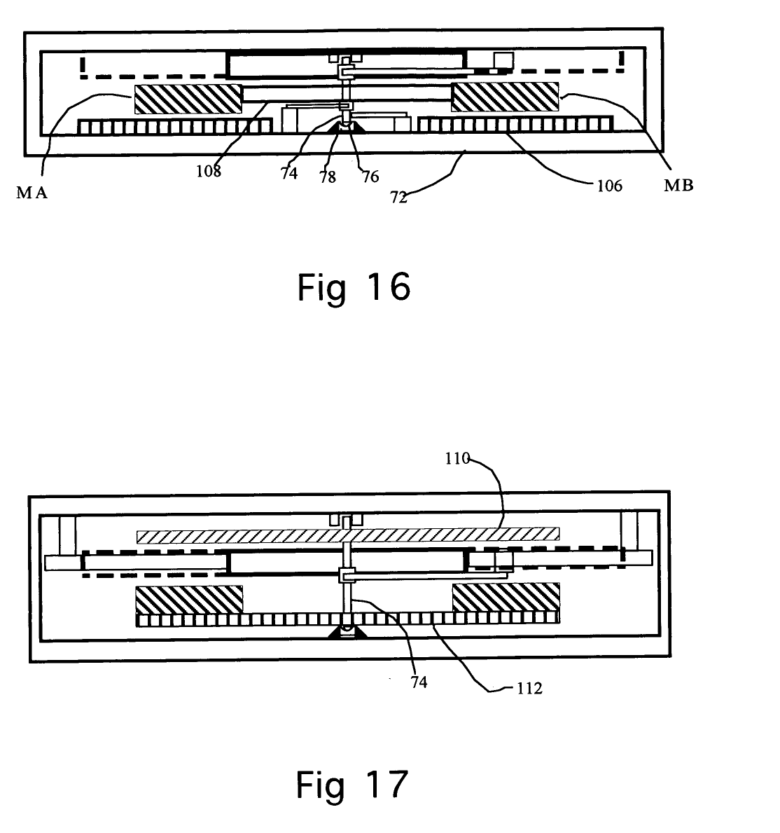

FIG. 16 shows a design like FIG. 13, except the disk 82 in FIG. 13a has been replaces by a fixed disk 106 that is fixedly attached to the motor case 72 proximate the magnets and on opposite side of it from the coils.

The magnets A and B are now fixedly attached to the axle 74 by means of a non-magnetic bracket 108. The gap between the fixed disk 106 and the magnets MA and MB should be as small as reasonably possible to facilitate flux transfer between the fixed disk 106 and the magnets A and B. The fixed disk 106 should be made of a soft magnetic material with a very low magnetic hysteresis do reduce the magnetic drag between the fixed disk 106 and the magnets MA, and MB. The advantage of this drive is that it reduces the load between the ball 76 and sapphire cup 78.

FIG. 17 shows a drive similar to that of FIG. 15, except a solar cell 110 has been fixedly attached to the to the top of the axle 74. The solar cell 110 can be a disk shape with a hole in the center to allow the axle to pass through. The source of electrical current is on the axle 74 itself, so the axle brush 88, ring brush 90, and slip-ring 92 of FIG. 15 have been eliminated. This allows the disk 82 to be a flat disk 112.

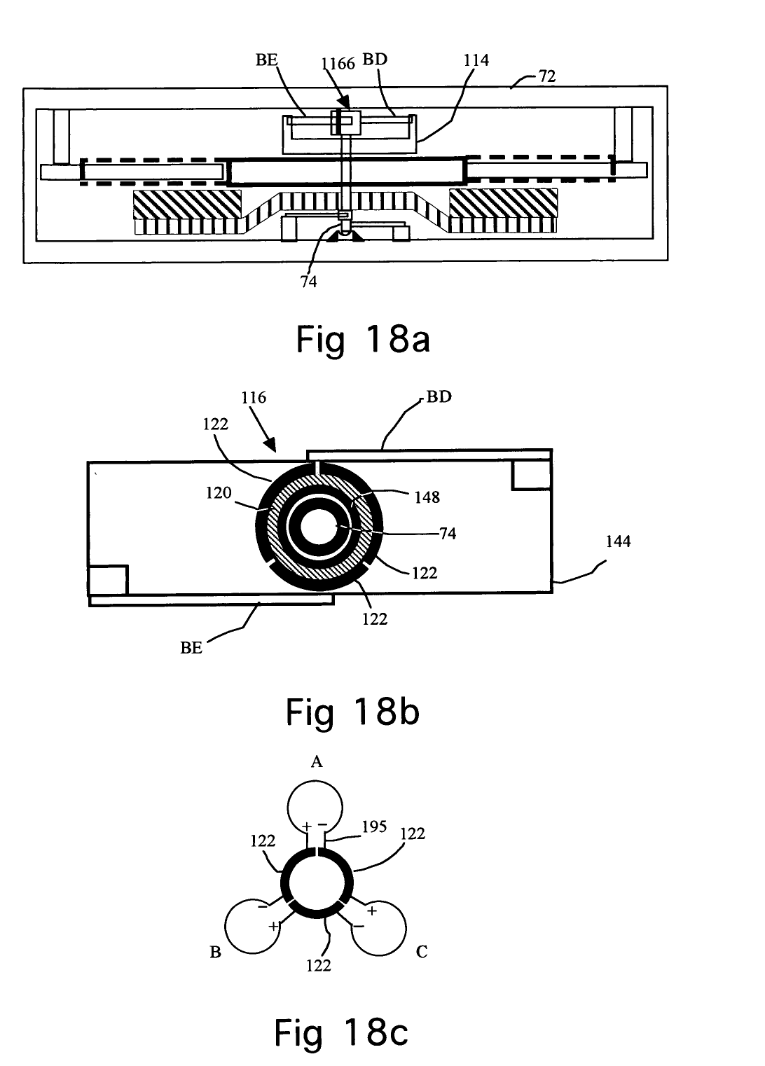

FIGS. 18a and 18b show an alternate commutation structure. A brush mounting bar 114 fixedly attached near the top of the axle 74 as shown. Brushes BD and BE are fixedly attached to the brush mounting bar 114 and the brushes BD and BE are positioned to rub on a three-segment split-ring assembly 116, which is fixedly attached to the motor case 72.

The three-segment split-ring assembly 116 is shown in closer detail in the top view of FIG. 18b. The axel 74 is shown as a hollow tube, constrained laterally by a tube 118 that forms the inside of the three-segment split-ring assembly 116. An insulating layer 120 surrounds the tube 148 and three slip-ring segments 122, each spanning a little less that 120° of the circimference of the three-segment split-ring assembly 116 are mounted on the outside of the layer of insulating material 120.

Electrical potential is supplied to conductors on the axle 74 as described for FIG. 13 and that potential is then conducted, by wires not shown fo clarity, to the brushes BD and BE, and through the sliding contact to the three-segment split-ring assembly 116 and then to the coils, A, B, and C. FIG. 18c shows an elelctrial schematic diagram of how the coils A, B and C are connected by conductors 95 to the theee slip ring segments, 122.

The structures shown in FIGS. 18a, 18b and 18c are new, but the the sequence of commutation that finally occurs is very well known in the art and will not be described here.

The various motor designs can be combined and and modified in many ways. For example, the design of FIG. 15 could be combined with the concept illustrated in FIG. 17, and the solar cell 110 could be mounted on the top iron disk 102.

The magnets MA and MB and the disk 82 could be replaced with a one piece disk shaped magnet made of isotropic magnetic material and magnetized to act like a compass.

The top iron disk 102 could be mounted on the motor case in the same way that disk 82 became disk 106 in FIG. 16. In this case, the magnetic attraction of the magnets A and B would tend to lift up the axle 74 and reduce the load on the bearing between the ball 76 and sapphire cup 78.

The spinning object in the center of the display device may be constituted by the motor case 72 itself. Alternately, the motor case may be attached inside the spinning object such as the ball 4 of FIG. 1 as illustrated in FIG. 21.

The following drive mechanism uses a quadrapole magnet that is able to generate torque by means of an interaction with an ambient magnetic field, such as the geomagnetic field, wherein said drive mechanism does not suffer from magnetic cogging, and wherein the armature of the said drive mechanism can be made of light weight materials to minimize the friction in the bearing that supports the armature for relative rotation.

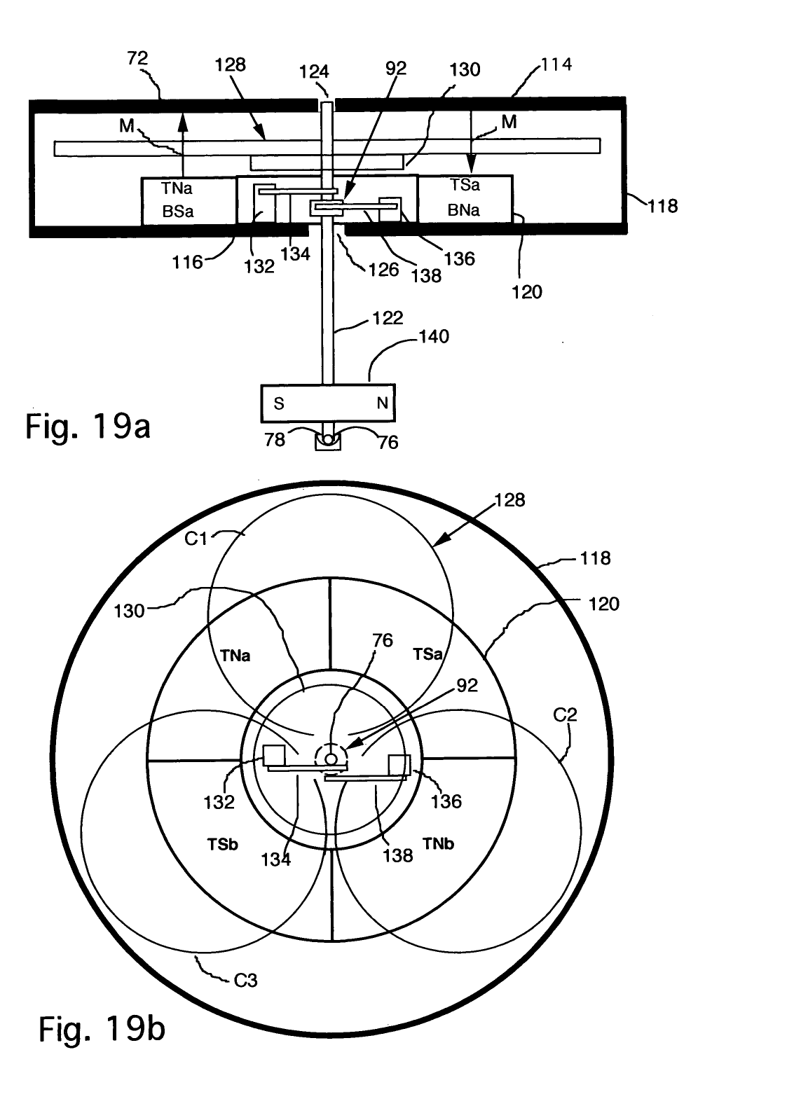

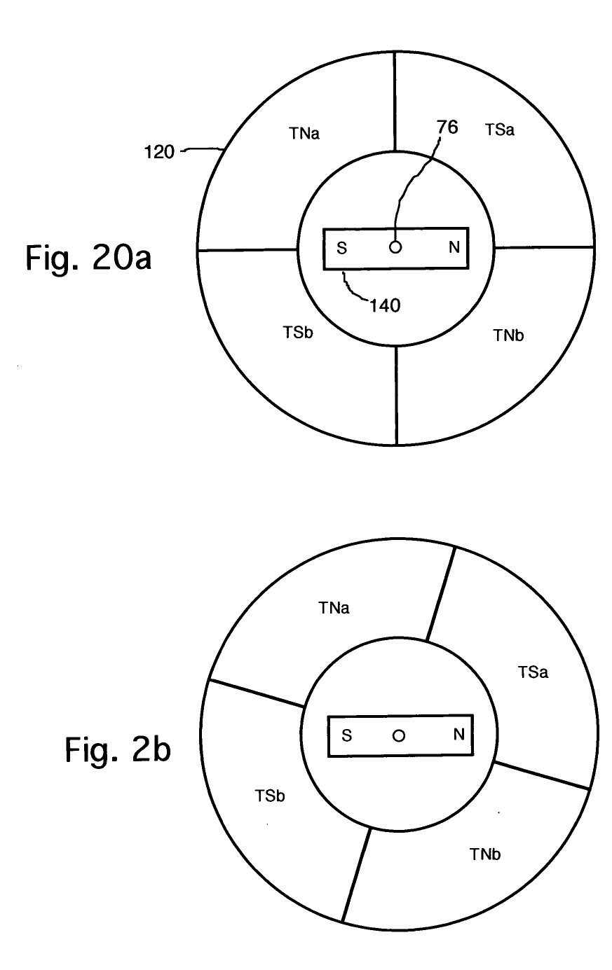

As illustrated in FIGS. 19a- 25b, FIG. 19a a motor case 72 comprises a disk-shaped motor top 114, a disk-shaped motor bottom 116, and a cylindrical wall 118. A ring shaped magnet 120 is contained within the motor case assembly 72. Said ring-shaped magnet 120 is coaxial with the shaft 122 and is magnetized parallel to its thickness direction and in a pattern that results in four regions of magnetization on its top surface, TNa, TSa, TNb, and TSb, as seen from the top in FIG. 19b. The “T” in these labels means the magnetic poles referred to are on the top of the ring shaped magnet 120, and the “N” and “S” mean magnetic north and south poles, respectively. The “a” and “b” letters denote which of the two pairs of north south poles is being referred to. FIG. 19a makes it clear that the ring-shaped magnet 120 also has a set of opposite poles on its bottom surface, shown as BSa (opposite TNa), BNa (opposite TSa). Not shown are BSb (opposite TNb) and BNb (opposite TSb).

The motor case 72 is made of magnetically soft, ferromagnetic metal, such as soft iron, and serves to provide a return path for magnetic flux generated by the ring-shaped magnet 120. The optimum thickness of the various parts of the motor case 72 is determined by very well known laws of magnetism, and depends on the exact geometry of the structure and on the properties of the ring-shaped magnet 120, and on the saturation flux density of the material that the motor case is made of. The object of the design is to create a strong magnetic field shown by the arrows M in the region between the top of the ring-shaped magnet 120, and the bottom surface of the motor top 114.

As an example, a motor was made with a soft iron motor case assembly with a motor top 0.12″ thick and 3.7″ in diameter. The motor bottom was 0.125″ thick with the same diameter as the top, and the cylindrical shell was 0.05″ thick. The ring shaped magnet 120 was made of grade 5 ferrite from A-L-L Magnetics, of Placentia, Calif. 0.33″ thick with an OD of 2.8″ an ID of 1.2″ The gap between the top of the ring shaped magnet 5, and the bottom surface of the motor top 2 was 0.175″ and the peak magnetic field strength was 2.1 kg.

The drive mechanism further comprises the shaft 122 supported for rotation on the bottom by a ball-shaped end 76 resting in a jewel bearing cup 78. Said shaft is constrained near its top by a journal bearing formed by the top part of shaft 122 and the inside surface of a hole 124 in the center of the motor top 114. A compass magnet 140, comprising a rod of permanently magnetized material such as NdFe, is attached to the bottom part of the shaft 122 with its NS axis perpendicular to the axis of the shaft. The drive mechanism is generally oriented with the shaft vertical so that the compass magnet is able to align itself orthogonally to the shaft with any ambient magnetic field, such as the geomagnetic field. The shaft 122 passes through a hole 126 in the motor bottom, and is attached to a slip ring assembly 92, and to a coil assembly 128 by means of a flange 130.

Electrical brushes 134 and 138 are mounted on the top surface of the motor bottom 126 by means of insulating mounting brackets 132 and 134. Electrical brush 134 makes contact with shaft 122 as it rotates, and electrical brush 138 makes contact with slip-ring assembly 92 as it rotates.

The coil assembly 128 is shown in cross section in FIG. 19a, but is much clearer in FIG. 19b with the motor top removed. This coil assembly comprises three-disk shaped coils of wire, C1, C2, and C3 attached to the flange 13 which is mounted on shaft 122 the coils are equally spaced apart around the axis of the shaft. FIG. 19b and subsequent figures show these coils as simply one turn of wire for simplicity, but is understood that they are actually made up of many turns in the same direction. Coils made for a the test motor described above were about 1.7″ OD×0.69″ ID×0.100″ thick and each had about 6000 turns of #44 gauge wire, thermally bonded to form a self-supporting coil.

FIGS. 20a and 20b show a top view of the ring-shaped magnet 120 and the compass magnet 140 mounted on the shaft 122 for the purpose of illustrating why there is virtually no torque generated about the axis of the shaft due to magnetic interactions between the compass magnet and the ring shaped magnet. Since all 2the magnetic poles of the ring shaped magnet 120 are the same size and strength, then the magnetic attraction between Pole TNa and the S pole of compass magnet 140, is exactly equal and opposite to the magnetic attraction that exists between Pole TSa and of the ring-shaped magnet and the N pole compass magnet; thus, these interactions generate no net torque. Similarly, the magnetic repulsions of poles TSb with the S pole of compass magnet 140, and the of pole TNb with the N pole result in no net torque. Furthermore, for similar reasons, magnetic interactions between poles TNa and TSb with the N pole of compass magnet produce no net torque, and the magnetic interactions between poles TSa and TNb with the S pole produce no net torque.

These same arguments can be applied when the orientation between the compass magnet 140 and the ring-shaped magnet 120 is at any arbitrary orientation as shown in FIG. 20b. In FIG. 20a pole S of the compass magnet 140 is now slightly closer to pole TSb of the ring-shaped magnet 120, and slightly further away from pole TNa; the net torque is still essentially the same, and is still opposite to that generated by poles TSa and TNb interacting with the N pole of the compass magent 140. Similar arguments can be made for the interactions of all the other pairs of poles, including the interactions of poles BNa, BSa, BNb, and BSb with the N and S poles of the compass magnet 140. Thus, in this idealized case, there is never any magnetic interaction between the ring-shaped magnet 120 and the compass magnet 140 that tends to relatively rotate them about the axis if the shaft 122.

The drive mechanism shown in FIGS. 19a and 19b can be mounted with in a ball 4 by mounting bracket 142 as shown in FIG. 21 to cause the ball to rotate. The coil assembly 128 is provided with electric current by means of wires, not shown that connect a solar cell 144 to the electrical brushes 134 and 138. It is assumed that the mass within the ball 76 is distributed in such a way that the while ball is bottom heavy and will float with the shaft 122 essentially vertical. The compass magnet 140 aligns itself with the ambient magnetic field AF, preferably the geomagnetic field. Currents applied to the coils C1, C2, and C3 will generate forces on the coils due to interactions with the magnetic fields produced by the ring magnet 120 to cause the ring magnet and everything attached to it to rotate. The coil assembly 128, shaft 122, compass magnet 1140, and slip-ring assembly 92 do not rotate.

Any magnetic interactions between the ring magnet 120 and the compass magnet 140 that would tend to prevent their relative rotation would interfere with the intended rotation of the ball. The description above makes it clear that the quadrapole design of the ring magnet 120 essentially eliminates any such cogging torques, even in the case where there is no motor case assembly is in place. Adding the motor case assembly 72 provides a return path for magnetic flux and greatly increases the strength of the magnetic field M in the region where the coils operate and thereby increases the torque the motor generates for any given current in the coils C1, C2, and C3. The motor case 72 also serves to magnetically shield the ring magnet 120 from the compass magnet 140 and thereby further eliminates any residual magnetic interactions between them that might occur because inconsistent magnetic properties in the various parts of the magnets, and imperfect geometry of the parts. Because of the intrinsic lack of magnetic interaction between the quadrapole ring-shaped magnet and the compass magnet, it is possible to design the motor case to be just thick enough to adequately provide a flux return path, and it is not necessary to make it significantly thicker and heavier, as would be necessary to shield the ring-shaped magnet and the compass magnet 18 if the magnetization pattern of ring shaped magnet 5 were a bipole, for example, and not a quadrapole.

The quadrapole ring-shaped magnet 120 also has virtually no cogging interaction with the ambient magnetic field, AF, for the same kinds of reasons that there is no cogging due to interactions with the compass magnet 140.

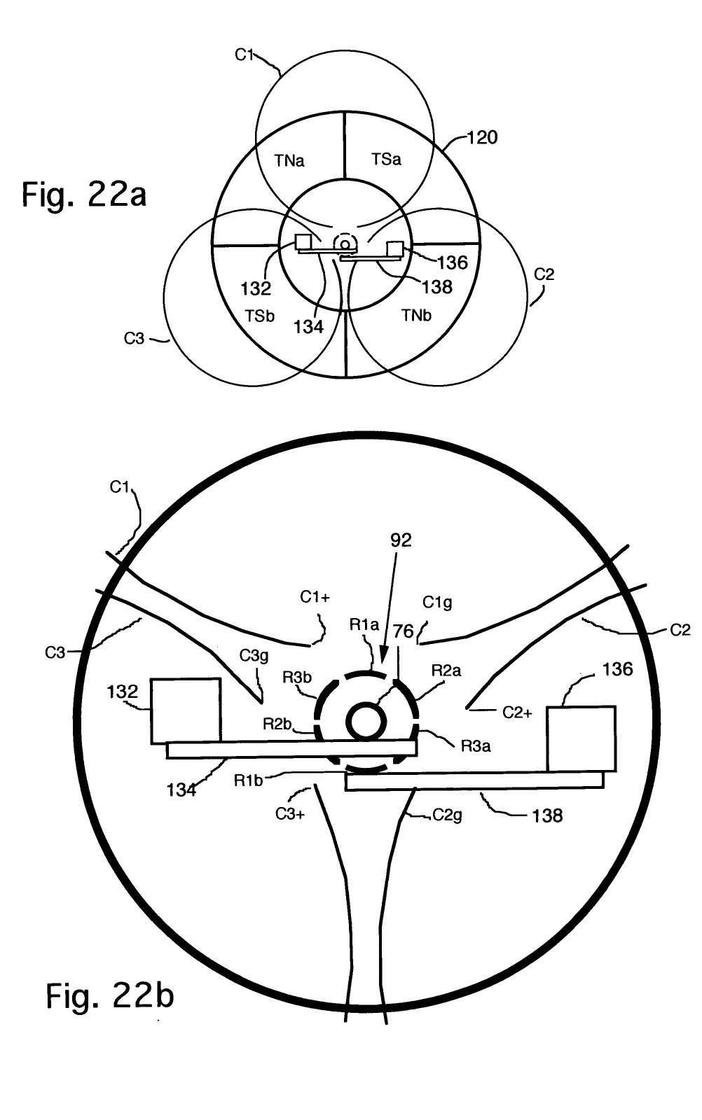

FIGS. 22b, 23b, 24b and 25b show how the current is distributed to the coils C1, C2, and C3 as the ring-shaped magnet 120 and all that is attached to it, rotate counterclockwise as seen from the top. The “a” Figures show the relative orientations of the poles on the top of the ring-shaped magnet and the coil assembly 128, and the “b” Figs. show an expanded top view of the region near the slip-ring assembly 92.

FIG. 22a shows coil C1 located symmetrically between poles TNa and TSa of ring-shaped magnet 120. Flange 130 is not shown for simplicity. FIG. 22b shows a greatly expanded view of the slip-ring assembly 92 comprising six segments, R1a, R2a, R3a, R1b, R2b and R3b, where C1+ is electrically connected to R1a and R1b, C2+ is electrically connected to R2a and R2b, and C3+ is electrically connected to R3a and R3b, by wires not shown for simplicity. The ends of coils C1, C2, and C3 denoted by C1g, C2g and C3g respectively, are all connected to the shaft 6 by wires not shown for simplicity. Electrical brush 134 is in contact with shaft 122 and electrical brush 138 is in contact with slip-ring segment R1b. The electrically negative terminal of solar cell 144 of FIG. 21 is connected to electrical brush 134 and the electrically positive terminal of solar cell 144 is connected to electrical brush 138, by wires not shown for simplicity. With these connections made and current flowing, the ring magnet will experience a force that will urge it to rotate counterclockwise.

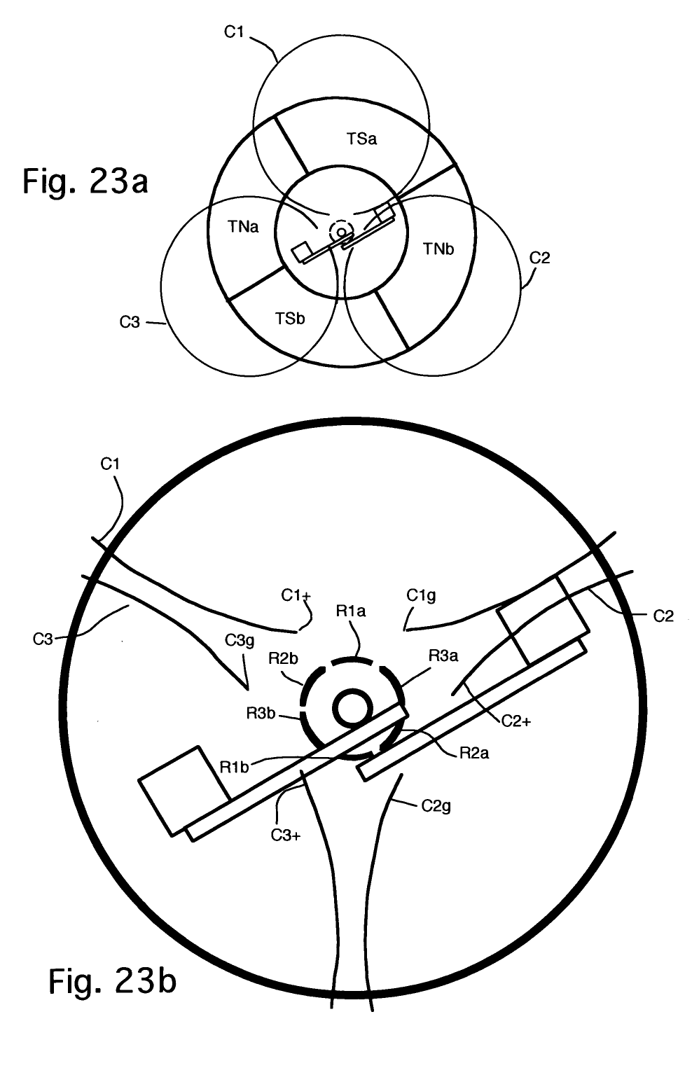

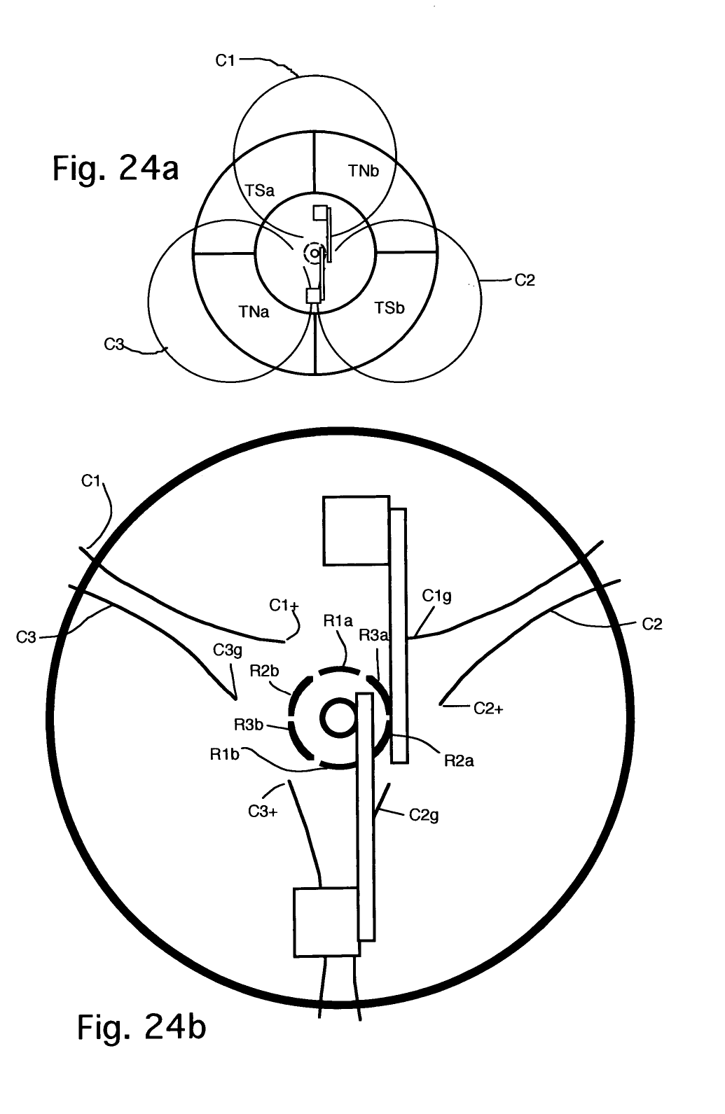

FIGS. 23a and 23b show the relative orientation that is reached after the ring magnet 120, and everything attached to it, has rotated 300 counterclockwise. It is assumed that the globe is free to rotate, and that the compass magnet 140 has held the coil assembly 128 in the fixed angular position as shown. In the 30° rotated orientation shown, slip ring segments R1b and R2a are momentarily both connected and provide current to coils C1 and C2 which both tend to drive the continued counterclockwise rotation of ring magnet 120, which will result in coil C2 being energized for the next 60° of counterclockwise rotation.

FIGS. 24a and 24b show the relative orientation that is reached after the ring magnet 120 and everything attached to it has rotated 90° counterclockwise. In the 90° rotated orientation shown, slip ring segments R2a and R3a are momentarily both connected and provide current to coils C2 and C3 which both tend to drive the continued counterclockwise rotation of ring magnet, which will result in coil C3 being energized for the next 60° of counterclockwise rotation.

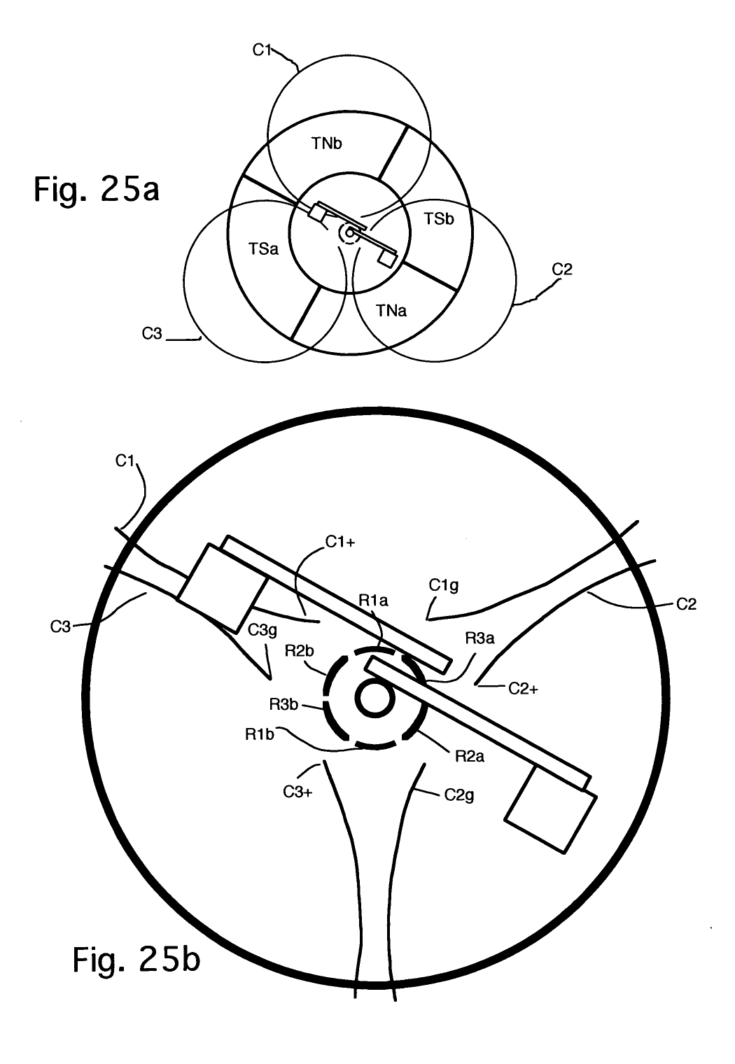

FIGS. 25a and 25b show the relative orientation that is reached after the ring magnet 120 and everything attached to it has rotated 150° counterclockwise. In the 150° rotated orientation shown, slip ring segments R3a and R1a are momentarily both connected and provide current to coils C3 and C1, which both tend to drive the continued counterclockwise rotation of ring magnet, which will result in coil C1 being energized for the next 60° of counterclockwise rotation. This commutation process continues as described, resulting in the continuous rotation of the ball 4.

In an example of the display, a compass magnet comprises two NdFe cylindrical magnets 0.375″ in diameter and 0.375″ long, each mounted in the end of rod of soft iron 0.85″ long for a total compass length of 1.6″. This compass magnet was mounted on the shaft 122 with the center of the compass 2.27″ below the lower surface of the motor case assembly 1. Magnetic cogging was insignificant.

It is clear that other commutation schemes could be arranged using different commutation ring structures. For example, starting in the orientation shown in FIG. 122a, coil C1 could be turned off after 15° of rotation and coil C3 then energized for 30° of rotation with a current of opposite direction from the current that was flowing in coil C1. Then coil C2 would be energized for the next 30° of rotation, using the same current direction as was used in coil C1, and so on.

The quadrapole magnetization pattern could by replaced by higher order patterns such as an octapole pattern. As the number of poles goes up the problem-of shielding the ring magnet from the compass magnet is reduced just because the fields emanating from small magnets placed close together do not have as great a spatial extent as do fields from larger magnets.

1. A display device which comprises:
a hermetic enclosure;
a first transparent fluid filling said enclosure; and
a movable object surrounded by said fluid;
wherein said first fluid includes a humectant solution of a first liquid and water in a ratio adjusted to minimize absorption of ambient moisture through said enclosure.

2. The device of claim 1, wherein:
said first fluid has a first density and a first index of refraction, and further includes a second liquid immiscible with said solution and having a second density different from said first density and a second index of refraction substantially similar to said first index; and
wherein the respective volumes of said solution and second liquid are adjusted to buoy the object in the absence of any mechanical link between the object and the enclosure.

3. The device of claim 2, wherein said first liquid comprises a hydrocarbon glycerine alcohol.

4. The device of claim 3, wherein said alcohol is taken from a group consisting essentially of Ethylene Glycol, Diethylene Glycol, Triethylene Glycol, Propylene Glycol and Diproplene Glycol.

5. The device of claim 3, wherein said second liquid is taken from a group consisting of essentially of PFPE 5060 and NOPAR 12.

6. The device of claim 2, wherein said enclosure is made of a material having an index of refraction substantially similar to said first and second indeces.

7. The device of claim 2, wherein said enclosure is made of a transparent material having an index of refraction substantially similar to said first and second indeces.

8. The device of claim 7, wherein said first liquid consists of Propylene Glycol, and said second liquid consists of NOPAR 12.

9. The device of claim 8, wherein said ratio per weight is approximately 88% first liquid and 12% water.

10. The device of claim 7, wherein said material is selected from a group consisting essentially of Pyrex glass, Acrylic, XPH-353 Fluoropolymer, Fused Quartz, Butyrate, and Methylpentene.

11. The device of claim 1 which further comprises:
a stationary pillar affixed to an inner section of said enclosure;
an electrical motor having a rotor and a stator, one of said rotor and stator being secured to said pillar, and the other of said rotor and said stator being secured to said object.

12. The device of claim 11, wherein said motor is located within said object.

13. The device of claim 12, wherein said enclosure and pillar are made from a transparent material having a first index of refraction and said first fluid has a second index of refraction substantially similar to said first index.

14. The device of claim 2 which further comprises:
an electrical motor having a shaft and being positioned below, and spaced apart from said object;
a first magnet having poles oriented orthogonally to said shaft and having a median section coupled to said shaft; and
a second magnet secured to said object and being positioned in an orientation parallel to said first magnet;
whereby the rotation of said first magnet by the motor induces rotation of said second magnet and object.

15. The device of claim 14 which further comprises said motor being embedded in a wall of said enclosure.

16. The device of claim 14 which further comprises a solar cell supplying electrical power to said motor.

17. The device of claim 2 which further comprises:
a second object; and
a transparent member linking said second object to said first object.

18. The device of claim 11 which further comprises:
a second object; and
a transparent member linking said second object to said first object.

19. The device of claim 17, wherein said second object is rotatively attached to said member, and includes a series of peripheral vanes shaped and positioned to induce a spinning movement of said second object when said first object is spun.

20. The device of claim 17 which further comprises:
a transparent cylindrical wall surrounding said first and second object; and
wherein said second object is rotatively attached to said member and includes a circular peripheral section in close proximity of said wall.

21. The device of claim 2, wherein said object comprises a sealed container and an electrical motor housed in said container and including:
a shaft oriented about a first axis and rotatively supported at either end by said container;
a bipolar magnet having poles oriented along a second axis perpendicular to said first axis and being fixedly attached at its center to said shaft;
whereby interaction of said magnet with a stationary ambient magnetic field keeps said shaft in a fixed rotational position;
said motor further including a ring-shaped magnet coaxial with said first axis, fixedly connected to said container, and having at least two pairs of positive and negative poles;
at least three coils proximate said second magnet, fixedly attached to said axle and circumferentially equally spaced apart around said first axis;
a source of electrical power; and
switching means for alternately energizing said coils from said source of power, and for inducing magnet torque forces between said coils and the poles of said second magnet to cause said second magnet and container to rotate about said shaft;
whereby the magnetic torque forces between said first and second magnets cancel one another and do not affect the movement of said container around said shaft.

22. The device of claim 21, wherein said container comprises a hermetically sealed hollow sphere.

23. The device of claim 2, wherein said object comprises a sealed container and an electrical motor housed in said container and including:
a shaft oriented about a first axis and rotatively supported at both ends by said container;
a first disk made of magnetically permeable material fixedly and axially connected to said shaft;
a pair of symmetrical, half-ring-shaped magnets positioned coaxially with said shaft upon said disk;
whereby interaction of said magnets with a stationary ambient magnetic field keeps said object in a fixed rotational position;
at least three coils proximate said magnets, said coil being fixedly attached to said container and circumferentially equally spaced apart around said axis;
a source of electrical power; and
switching means for alternately energizing said coils from said source of power and for inducing magnetic torque forces between said coils and said magnet to cause coils and container to rotate about said shaft.

24. The device of claim 23, wherein said motor further includes an iron disk axially positioned proximate said coils opposite said first disk.

25. The device of claim 23, wherein said motor further includes a disk of soft magnetic material axially positioned proximate said magnet opposite said coils.

26. The device of claim 23, wherein said source of electrical power comprises a solar cell attached to said container.

27. The device of claim 23, wherein said switching means comprises:
a split-ring mounted on said shaft and contact brush commutator, wherein:
said split-ring comprises three segments, each segment being fixedly connected to a positive end of one coil and to a negative end of another coil; and
wherein said commutator comprises two brushes connected to a pole of said source of power and contacting said split-ring at diametrically opposite points.

28. A display device which comprises:
a hermetic enclosure made of a transparent material having a given index of refraction;
a first transparent fluid filling said enclosure; and
a movable object surrounded by said fluid;
wherein said first fluid includes a humectant solution of a first liquid and water in a ratio adjusted to match said index of refraction.

29. A display device which comprises:
a hermetic enclosure;
a first transparent fluid in said enclosure; and
a movable object immersed into said fluid; and
an electrical motor rotationally driving said object;
wherein said electrical motor comprises:
a shaft oriented about a first axis and rotatively supported at either end by said container;
a bipolar magnet having poles oriented along a second axis perpendicular to said first axis and being fixedly attached at its center to said shaft;
whereby interaction of said magnet with a stationary ambient magnetic field keeps said shaft in a fixed rotational position;
said motor further including a ring-shaped magnet coaxial with said first axis, fixedly connected to said container, and having at least two pairs of positive and negative poles;
at least three coils proximate said second segment, fixedly attached to said axle and circumferentially equally spaced apart around said first axis;
a source of electrical power; and
switching means for alternately energizing said coils from said source of power, and for inducing magnet torque forces between said coils and the poles of said second magnet to cause said second magnet and container to rotate about said shaft;
whereby the magnetic torque forces between said first and second magnets cancel one another and do not affect the movement of said container around said shaft.

30. A display device which comprises:
a hermetic enclosure;
a first transparent fluid in said enclosure;
a movable object immersed into said fluid; and
an electrical motor rotationally driving said object;
wherein said electrical motor consists of:
a shaft oriented about a first axis and rotatively supported at both ends by said container;
a first disk made of magnetically permeable material fixedly and axially connected to said shaft;
a pair of symmetrical, half-ring-shaped magnets positioned coaxially with said shaft upon said disk;
whereby interaction of said magnets with a stationary ambient magnetic field keeps said object in a fixed rotational position;
at least three coils proximate said magnets, said coil being fixedly attached to said container and circumferentially equally spaced apart around said axis;
a source of electrical power; and
switching means for alternately energizing said coils from said source of power and for inducing magnetic torque forces between said coils and said magnet to cause said coils and container to rotate about said shaft.
